(19) United States
(12) Patent Application Publication
(10) Pub. No.: US 2009/0127866 A1
(43) Pub. Date: May 21, 2009

(54) HYDROELECTRIC DEVICE FOR HARNESSING THE BUOYANT FORCE OF AN OBJECT IN A FLUID

(76) Inventor: Larry COOK, Jefferson City, MO (US)

Correspondence Address: SPENCER, FANE, BRITT & BROWNE, 1000 WALNUT STREET, SUITE 1400, KANSAS CITY, MO, 64106-2140, US

(21) Appl. No.: 12/272,585

(22) Filed: Nov. 17, 2008

Related U.S. Application Data
(60) Provisional application No. 60/988,760, filed on Nov. 16, 2007.

(51) Int. Cl. F02B 63/04

(52) U.S. Cl. 290/1 R

(57) ABSTRACT

The present invention provides, in one embodiment, a device for producing electricity, the device including a housing having a volume of fluid therein, a rotor within the housing, the rotor being in fluid communication with the housing and fixedly attached to a shaft. At least one buoy is sized and shaped to move through the fluid in housing, as well as though an inlet and outlet of the housing. An electrical generator is coupled to the shaft to which the rotor is attached. When a buoy moved into the housing through the inlet, it rises in the fluid and is received by the rotor, causing the rotor to turn as the buoy continues to rise. The turning of the rotor operates the electrical generator.

### CROSS-REFERENCE TO RELATED APPLICATIONS

This Application claims priority of U.S. Provisional Patent Application No. 60/988,760, filed on Nov. 16, 2007, which is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### BACKGROUND OF THE INVENTION

The present invention relates generally to a hydroelectric energy-producing device, and more specifically to a device adapted to harness the buoyancy of objects to produce energy or perform work.

For thousands of years, mankind has harnessed the power of water to produce energy and perform work. Ancient Greeks used water wheels to grind wheat into flour more than two-thousand years ago. Later, during the height of the Roman Empire, water wheel technology spread throughout Europe. Over the subsequent millennia, hydropower technology has spread to a variety of applications, including the production of electricity.

Early water wheels were horizontal in nature, consisting of vanes protruding from a wooden rotor or, later, full wheels mounted horizontally on a wooden shaft. Such wheels were placed in a moving body of water, and the resulting movement imparted by the wheel to the rotor or shaft was used to perform work.

More powerful vertical wheels were developed later, and as technology progressed gearing was used to augment the power of various water wheel configurations. Vertical water wheels are typically classified as either undershot water wheels, where a bottom portion of the wheel is submerged in a moving body of water, which in turn produces the turning motion of the wheel, or overshot water wheels, wherein water impacts the wheel from above, often from specially designed channels. Overshot water wheels have the advantage of utilizing the force of gravity on a mass of water, in addition to the force of the current in the body of water in which the water wheel is situated.

Regardless of the specific type or configuration of water wheel employed, conventional water wheels suffer from drawbacks related to the body of water in which they are situated. The power generated by any given wheel relies directly upon the force of the body of water in which the wheel is located. This reliance requires first and foremost a suitable body of water in which to place the water wheel before it can be used to perform work or generate electricity. In areas in which no suitable body of water is present, the ability to use a water wheel is lost. Even in those areas in which a suitable body of water is located, the properties of that body of water, particularly water level and flow rate, can vary widely over time. Time and resources used to place a water wheel in a suitable body of water can later be lost when the body of water changes sufficiently that the water wheel no longer generates a required amount of power. As global temperatures changes and the incidence of drought increases in some geographic areas, those areas that may once have relied on water wheels may find the ability to continue that reliance to be limited. Nevertheless, the simplicity of a water wheel and the ability to rely on natural forces to do work or create electricity render such devices highly desirable.

What is needed, therefore, is a novel energy-producing device that incorporates the principles of the water wheel in a wholly new manner, and allow for the use of the natural properties of water to do work or generate electricity regardless of the surrounding environmental conditions.

### BRIEF DESCRIPTION OF THE DRAWINGS

FIG. 1 is a cross-sectional perspective view of one embodiment of a device constructed in accordance with the teachings of the present invention.

FIG. 2 is a front view of a tank assembly of an embodiment of the present invention.

FIG. 3 is a front view of an embodiment of a rotor assembly of the present invention.

FIG. 4 is a front view of an embodiment of a tank assembly of the present invention.

FIG. 5 is a plan view of one embodiment of a buoy return and magazine assembly of the present invention.

FIG. 6 is a plan view of one embodiment of a pneumatic piston assembly of the present invention.

FIG. 7 is a plan view of an inflatable embodiment of a buoy of the present invention.

FIG. 8. is a front cross-sectional view of one embodiment of the present invention.

FIG. 9 is a plan view of one embodiment of a tank of the present invention.

FIG. 10 is a schematic view of one embodiment of components of the present invention.

FIG. 11 is a front view of one embodiment of the present invention.

FIG. 12 is a perspective view of one embodiment of a starter gear of the present invention.

FIG. 13 is a perspective view of one embodiment of a starter motor of the present invention.

FIG. 14 is an exploded view of one embodiment of a timing assembly of the present invention.

FIG. 15 is a rear view of one embodiment of the present invention.

### SUMMARY OF THE INVENTION

The present invention provides, in one embodiment, a device for producing electricity, the device including a housing having a volume of fluid therein, a rotor within the housing, the rotor being in fluid communication with the housing and fixedly attached to a shaft. At least one buoy is sized and shaped to move through the fluid in housing, as well as though an inlet and outlet of the housing. An electrical generator is coupled to the shaft to which the rotor is attached. When a buoy moved into the housing through the inlet, it rises in the fluid and is received by the rotor, causing the rotor to turn as the buoy continues to rise. The turning of the rotor operates the electrical generator.

The volume of fluid contained within the housing has a first density, and the at least one buoy has a second density. The first density is greater than the second density so that the buoy will rise in the fluid. The greater the difference in density, the more momentum achieved by the at least one buoy.

In some embodiments of the present invention, the buoys are made of metal, wood, synthetic polymers, carbon fiber, foam, and combinations thereof. The buoy may also be inflatable.

In one embodiment of the present invention, the at least one buoy is hollow.

In another embodiment of the present invention the at least one buoy is filled with a gas. The gas may be any suitable gas or combination of gases. In some embodiments of the present invention the gas is helium or hydrogen.

In another embodiment of the present invention, the at least one buoy is hollow and contains a vacuum.

Another embodiment of the present invention provides a device for producing electricity, the device including a housing containing a volume of fluid and having an inlet and outlet, a rotor in the housing and in fluid communication with the housing, the rotor also attached to a shaft, a buoy return track extending from an outlet of the housing and adapted to receive buoys emerging from the housing and direct them to the buoy magazine cage, and an inlet tube attached at a first end to the buoy magazine cage and at a second end to an inlet of the housing, for directing buoys into the housing.

Another embodiment of the present invention includes a receiving portion attached to the arms of the rotor and adapted to receive at least one buoy.

Still another embodiment of the present invention includes a fin attached to a length of the arms of the rotor, the fin adapted to be pushed by the impact of fluid within the housing.

Another aspect of the present invention includes an insertion mechanism for impacting a first buoy and thereby forcing a second buoy into the housing.

Still another aspect of the invention includes a timing mechanism to ensure that the insertion mechanism forces a buoy into the housing when an arm of the rotor is in position to receive the buoy.

### DETAILED DESCRIPTION OF THE INVENTION

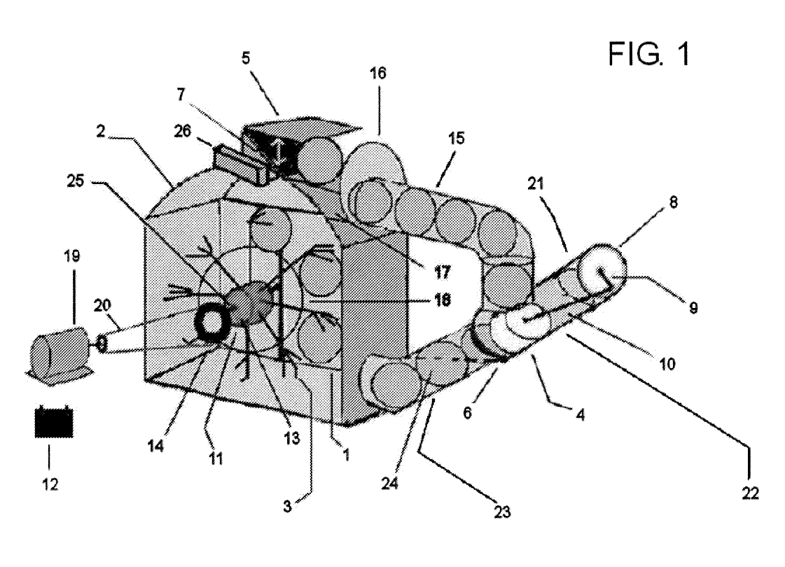

The present invention provides a device that combines the general principles of the water wheel with a novel configuration designed to harness the properties of buoyant objects, so that the water wheel principles can be implemented without the geographical and other limitations of a conventional water wheel. A detailed discussion of one embodiment of the present invention, shown in FIG. 1, is now provided, followed by a more general discussion of this and alternative embodiments of the present device.

As shown in FIG. 1, the present device includes a tank or housing 2, in which the primary power-producing components of the present device are located. Located within housing 2 is a rotor hub 11 mounted on a shaft 13. Protruding from shaft 13 are a plurality of supports 18 that terminate in fins 3. In addition to having rotor hub 11 mounted thereon, shaft 13 also engages a pulley 14, which rotates as the rotation of shaft 13 imparts rotational energy thereto. Pulley 14 is associated with an electric generator 19 via belt 20.

During normal operation of the present device, housing 2 is preferably filled with water or other fluid. Located at the top of the tank is an exit door 5 that includes a water-tight seal 7. Located near a bottom of housing 2 is an intake tube 23, which is in fluid communication with housing 2 and is of sufficient diameter to contain buoys 1. An opening in housing 2 at the location where intake tube 23 and housing 2 meet is preferably of the same or larger diameter, as is an opening at the top of housing 2 where exit door 5 and housing 2 meet.

A funnel-shaped shroud 16 is positioned along an upper portion of tank 2 to direct buoys 1 moving through exit door 5 into magazine tube 15 (as will be further described below). Magazine tube 15 preferably slopes downward along at least a portion of its length and opens into intake tube 23. Located within intake tube 23 are a crank shaft 9, a plunger shaft 10, and a plunger valve 4. Crank shaft 9 is preferably powered by a small electric motor associated with electric generator 19.

The general principles of operation of the embodiment of the present device shown in FIG. 1 are now described. Operation of the device may be initiated, for example, by a battery 12, or in any other suitable manner. Once operation of the device is initiated, the power requirements of the device itself can be sustained by electric generator 19, although an external power source may also be utilized in some embodiments of the present device.

Once operation of the present device has been initiated, buoys 1 enter housing 2 via intake tube 23. A can be seen in the figure, multiple buoys 1 are utilized, with force exerted against a rearmost buoy 1 in intake tube 23 being used to propel a forward-most buoy 1 into tank 2. Force is required because this initial propulsion works against the natural tendency of buoys 1 to rise against the water level in intake tube 23. Once a buoy 1 enters housing 2, which is full of water, the natural tendency of buoy 1 is to rise. Buoy 1 is captured by one of fins 3 as it rises through the water contained within tank 2, and the rising motion of buoy 1 causes a corresponding rotation of rotor hub 11 and, therefore, shaft 13 due to the action of buoy 1 against a fin 3. As soon as a first buoy 1 has entered tank 2 and begun to rise, providing clearance for a second buoy 1 to enter tank 2, the second buoy 1 enters tank 2 and also begins to rise, therefore also being captured by a fin 3. It is contemplated that gearing may be used to translate the rotations per minute (rpms) rotor hub 11 produced by buoys 1 into greater rpms to power electric generator 19. For example, in an embodiment of the present invention wherein 300 rpms are produced in rotor hub 11, a 6:1 gear ratio may be used to provide 1800 rpms at the point of electric generator 1. It is contemplated that such gearing, and other methods or structures known for manipulating the rpm output of the present device will be readily apparent to those of ordinary skill in the art upon reading this disclosure.

Before continuing the description of the operation of the present device, buoys 1 are described in greater detail. Buoys 1 may be constructed of any suitable material or combination of materials. It is contemplated that buoys 1 may be solid, hollow, porous, or provided in any other structure or form. Buoys 1, for example, may include a sturdy outer shell, such as a shell constructed from steel, aluminum, or other metal, and may have a hollow interior designed to provide buoyancy to the buoy. Alternatively, buoys 1 may be filled with a gas in order to create a greater buoyancy of buoys 1. A vacuum may also be created within buoys 1 to increase buoyancy. Buoys 1 may, alternatively, be constructed from a foam core, using for example Styrofoam or other suitable material, encased in a strong outer shell, thereby providing greater buoyancy while retaining a strong outer structure to prevent or mitigate damage to buoys 1 during normal operation of the present device. The interior of buoys 1 may also be constructed from a syntactic foam, being a foamy material including numerous gas bubbles associated therewith. The outer shell of buoys 1, whether buoys 1 are hollow or otherwise, may, in addition to being constructed from various metals, be constructed from wood, carbon fiber, various synthetic polymers, and the like. With many such materials such as, for example, wood, buoys 1 may be solid and constructed from a single material, providing both strength and buoyancy to buoys 1.

Construction of buoys 1 may vary according to the general principles of buoyancy. So long as buoys 1 are lighter than the volume of fluid they displace (i.e. are less dense than the fluid they displace) positive buoyancy results and buoys 1 will rise. The greater the difference between the weight of fluid displaced, or the density thereof, and the weight or density of buoys 1, the greater the positive buoyancy of any given buoy 1. Thus, it will be apparent to those of skill in the art upon reading this disclosure that optimization of the present device may include either changes in the physical properties of buoys 1, the properties of the fluid in tank 2, or both. In the discussion above, it is assumed that water is provided as the fluid within tank 2. Sea water, though, has a density slightly above that of normal water, and therefore may be utilized in the present invention to greater advantage, provided that the present device is constructed from materials resistant to damage or disrepair by the effects of sea water. Other high-density fluids may also be utilized, although it is preferred that any fluid used in conjunction with the present device have a relatively low viscosity such that the viscous nature of the fluid does not counteract or override the benefits gained from using a fluid having a higher density than water. Examples of fluids that have density greater than water but have relatively low viscosities include mercury, perchloroethylene, tetrachloromethane, and dichloromethane. Other examples include supercritical fluids, which are maintained at conditions above their critical temperatures and pressures. Both carbon dioxide and water can serve as supercritical fluids. Furthermore, any suitable synthetic fluid having high density and low viscosity may be adapted for use with the present invention.

Combinations or mixtures of fluids may also be used. The specific composition of the fluid used with the present invention, or indeed of buoys 1, does not limit the present invention. Any fluid or materials having suitable properties may be used. With respect to some of the exemplary fluids mentioned above, such as mercury, dichloromethane, and the like, hazardous properties of the fluids (or other practical considerations such as weight) make them less than desirable substances for use with the present invention. It is preferred that the present invention be constructed using water as the fluid within tank 2, or that a non-hazardous, environmentally-sound alternative, whether naturally-occurring or synthetic, be chosen. In order to further optimize the present device, the resistance to motion presented by rotor hub 11 and associated fins 3 should also be taken into consideration when determining which materials are most useful for any given embodiment of buoys 1 or the fluid contained within tank 2.

Returning to the principles of operation of the present device, as buoys 1 move through tank 2, thereby causing rotation of rotor hub 11 and, correspondingly, of shaft 13, buoys 1 reach the top of tank 2 and exit through exit door 5. After moving through exit door 5, buoys 1 are redirected to intake tube 23 via magazine tube 15. Crank shaft 9 is, at this point, in operation, causing movement of plunger shaft 10 and a corresponding movement of plunger valve 4 along a portion of the length of intake tube 23 (this portion of intake tube 23 also being referred to herein and in the figure as plunger tube 22). The action of plunger valve 4 forces movement of a buoy 1 entering intake tube 23 from magazine tube 15 through airtight valve seat 6, whereupon the buoy 1 impacts another buoy 1 and forces a third buoy 1 into tank 2. Thus, the movement of buoys 1 through the present device is cyclical in nature. It is contemplated that the movement of buoys 1 through the present device may be optimized by, for example, adjusting the timing of the action of plunger valve 4 to most efficiently propel buoys 1 into tank 2. Further, it is contemplated that timing mechanism may be provided to monitor or adjust the timing between crank shaft 9 and rotor hub 11 (or shaft 13) in order to ensure proper functioning of the device. A check valve or vacuum breaker (not shown) is preferably provided in either magazine tube 15 or plunger tube 22, preferably as close as practical to airtight valve seat 6, for releasing a vacuum contained within the present device during the return action of plunger valve 4. It is contemplated that a check value or vacuum breaker could be located in plunger valve 4 as an alternative to locating such a valve or vacuum breaker in magazine tube 15 or plunger tube 22. It is further contemplated that rather than employ a crank shaft 9 and plunger valve 4, any other suitable means of forcing a buoy 1 further along the length of intake tube 23, and thereby forcing a separate buoy 1 into tank 2, including the use of a piston or solenoid. Further, such forcing mechanisms may be eliminated and a mechanism of pulling a buoy 1 into tank 2 may be utilized, such as, for example, using a magnetic field to pull a buoy 1 into tank 2, in embodiments of the present invention wherein buoys 1 are constructed from a material susceptible to a magnetic field.

The general principles of operation of the present device have been described above. Preferred aspects of other components of the present device are now described, although it is noted that the various descriptions provided herein are exemplary in nature and are not to be considered as limiting the present invention. Plunger valve 4, for example, is preferably long enough to obstruct the interface between magazine tube 15 and intake tube 23 such that a buoy 1 does not enter intake tube 23 out of sequence or at an undesired time. Other suitable methods for preventing an undesired entry of a buoy 1 into intake tube 23 may also be utilized. Plunger valve 4 is also preferably constructed from a closed cell poly-foam, although any suitable material may be utilized, and preferably fits snugly against the wall of plunger tube 22, thereby creating a seal that prevents displaced water from the present device from backing up into plunger tube 22. When the present device is initially filled with fluid, plunger valve 4 should be firmly locked into position against airtight valve seat 6. During operation of the present device, when plunger valve 4 is snug against airtight valve seat 6, downward pressure is released from exit door 5, allowing a topmost buoy 1 that has been released by a rotor fin 3 as it reached the apex of tank 2 to push open exit door 5 and move out of tank 2 (it should be noted that the topmost buoy 1 must have sufficient force, imparted by its buoyancy, to impact and open exit door 5). Any fluid displaced by the motion of buoy 1 out of tank 2 is preferably routed into closed reservoir 26 via a tube located just beneath the exit door seal. When exit door 5 is opened, any fluid contained within reservoir 26 is released and returned to tank or housing 2 by the force of gravity. In another aspect of the timing of the present invention, it should be noted that airtight valve seat 6 and exit door 5 cannot both be open at the same time in order to properly maintain the level of water or fluid within tank or housing 2.

The above description of the present invention is exemplary and is not meant to limit the present invention. Variations and modifications to the structure described herein will be apparent to those of skill in the art upon reading this disclosure and are considered well within the scope of the present invention. Any suitable structure or materials may be used that make use of buoyant objects to provide motion to a structure coupled to an electric generator.

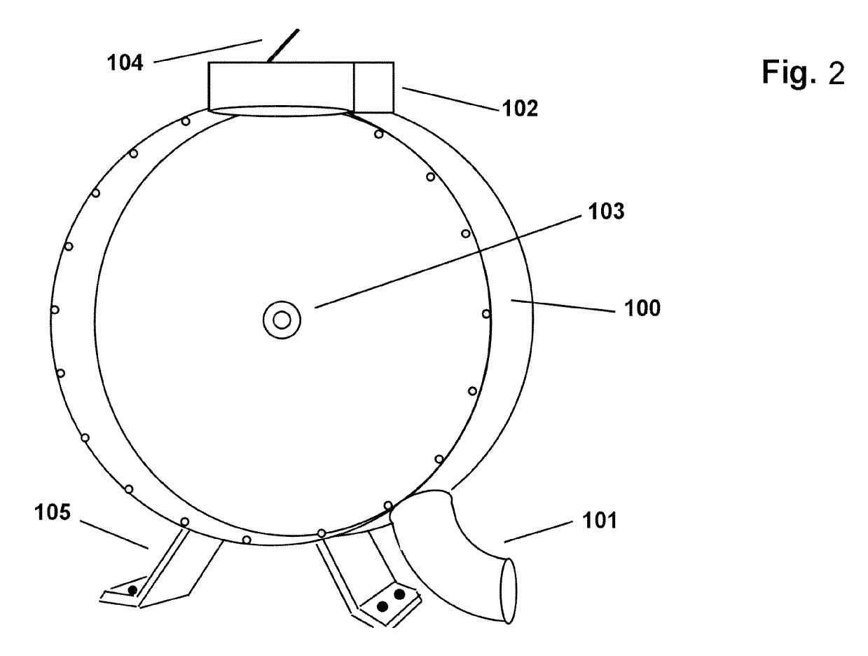

Another exemplary embodiment of the present invention is shown in FIGS. 2 through 15 and described in further detail below. FIG. 2 provides a front view of a tank assembly of an embodiment of the present invention. The tank assembly includes a tank 100, motor mounting brackets 105, buoy insertion tube 101, rear bearing 103, displaced water receptacle 102, and buoy deflector 104.

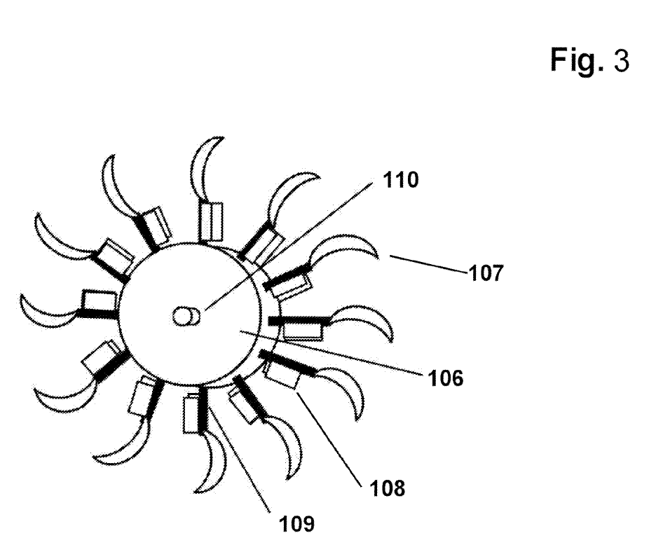

FIG. 3 provides a front view of an embodiment of a rotor assembly of the present invention. The rotor assembly includes a motor shaft 110, hub 106, fin support rods 109, push wings 108, and drive fins 107.

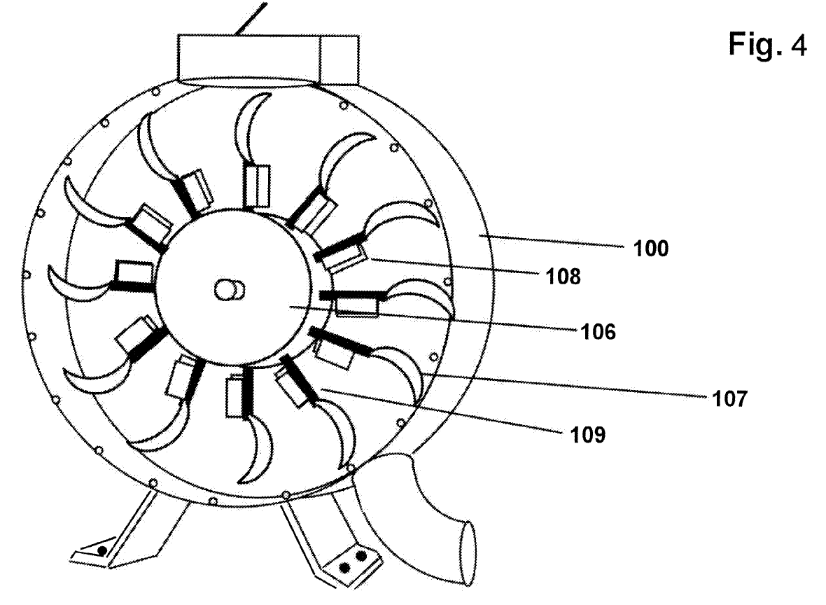

FIG. 4 provides a front view of a tank assembly of the present invention, with a rotor assembly placed in operable position with the tank assembly. Again tank 100 is shown, as are hub 106, drive fins 107, push wings 108, and fin support rods 109 of the rotor assembly.

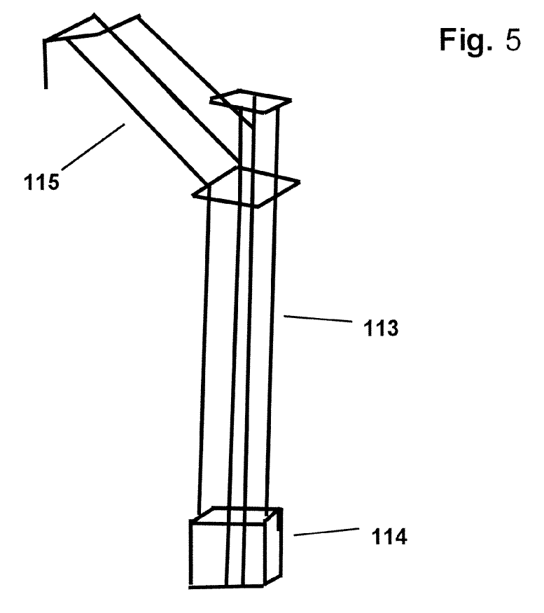

FIG. 5 is a view of one embodiment of a buoy return and magazine assembly of the present invention. The buoy return assembly includes a buoy return track 115, buoy magazine cage 113, and buoy delivery compartment 114.

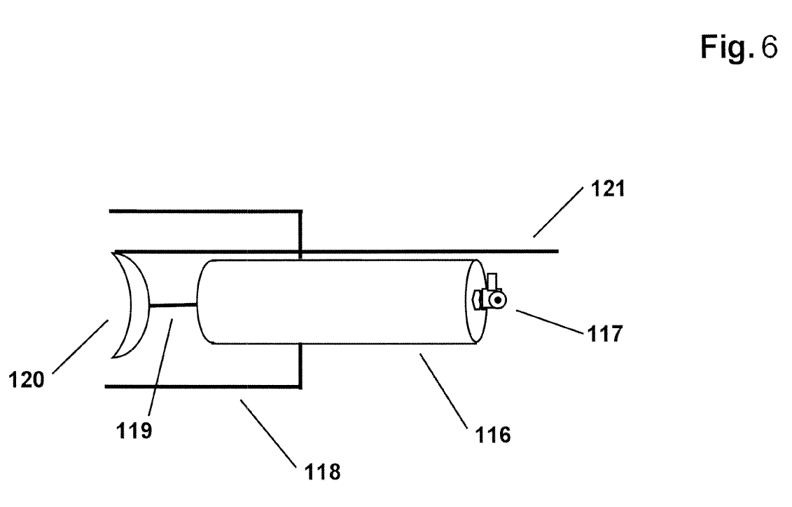

FIG. 6 provides a view of an embodiment of a pneumatic piston assembly of the present invention. The piston assembly includes a cylinder 116, piston and rod 119, drive head 120, solenoid valve 117, buoy retention rod 121, and mounting bracket 118.

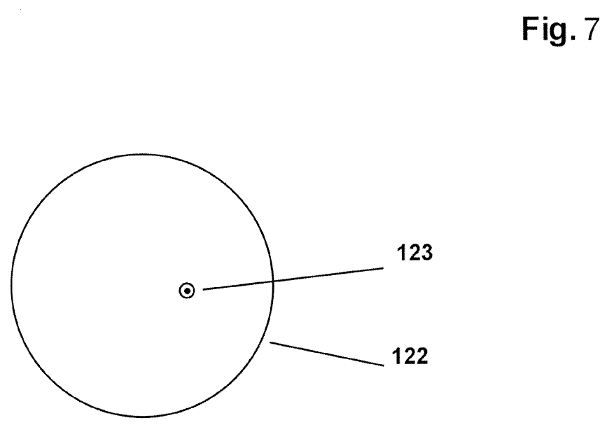

FIG. 7 is a view of an inflatable embodiment of a buoy 122 of the present invention. Inflatable buoy 122 includes an inflation valve for inflating buoy 122 for use with this embodiment of the present invention.

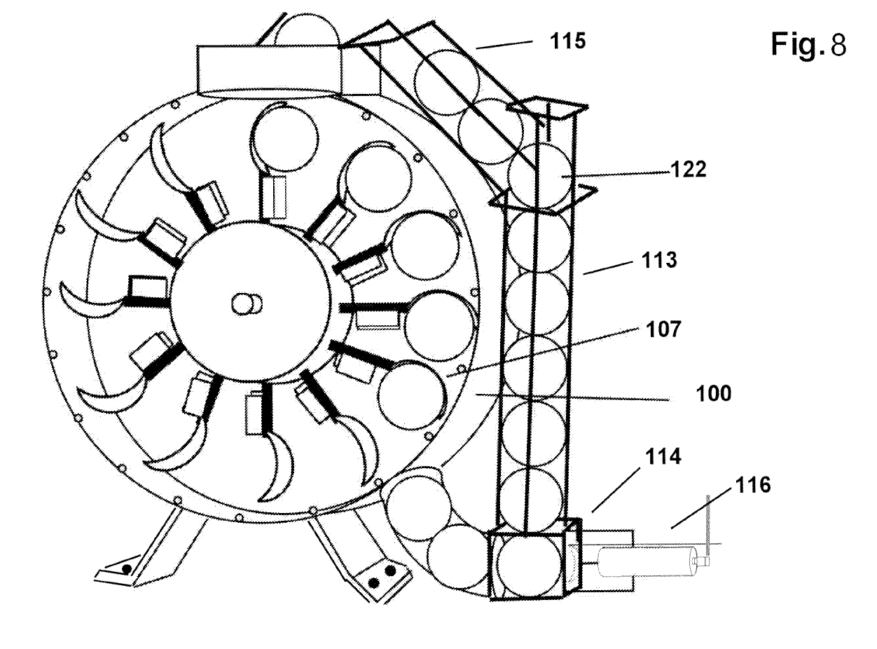

FIG. 8 is a front view of an embodiment of the present invention having a tank assembly, buoy return and magazine assembly, pneumatic piston assembly, rotor assembly, and buoys in operable position. Operation of this embodiment of the assembled device is further described below.

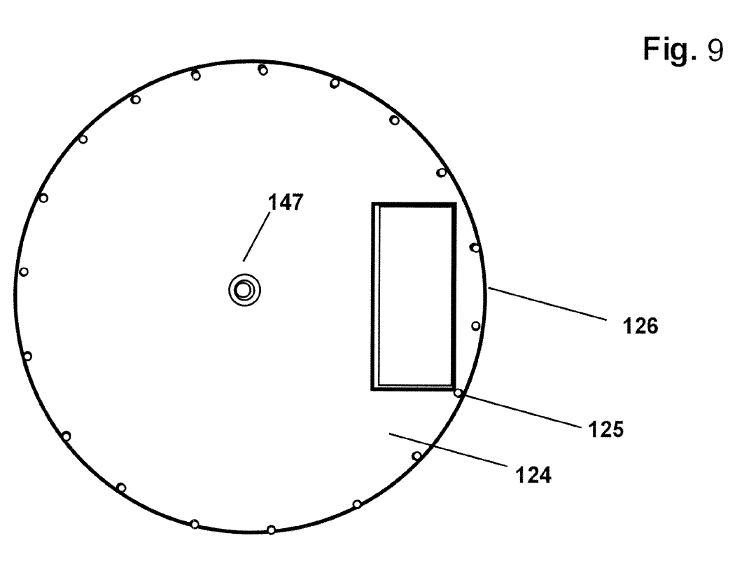

FIG. 9 is a view of another embodiment of a tank of the present invention, the tank having a panel 124 enclosing an interior of the tank, a view port 125 for viewing the internal components of the device, a seal 126 for maintaining the tank in a water-tight condition, and a front bearing 147.

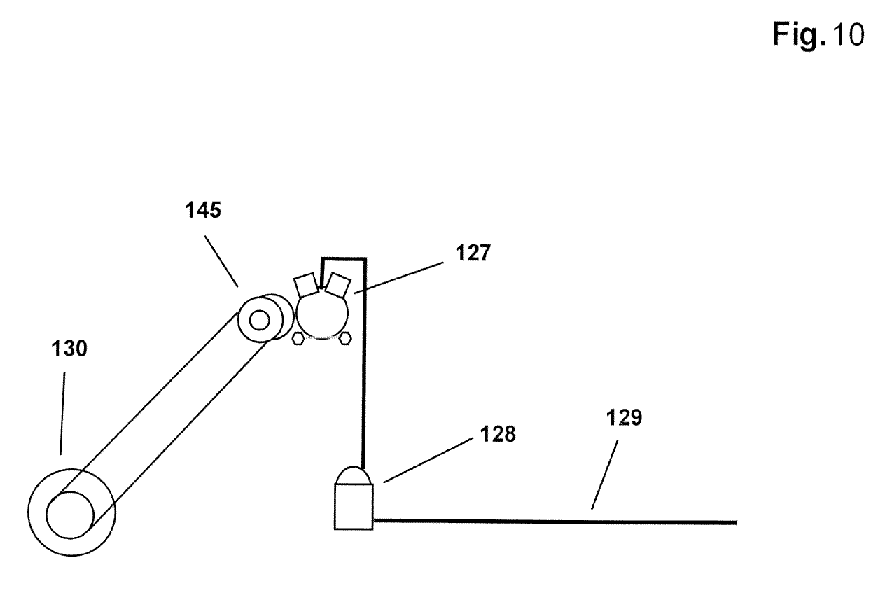

FIG. 10 is schematic view of one embodiment of components of the present device external to tank 100. The view depicts motor pulley 145, air compressor 127, compressed air storage tank 128, compressed air line 129, and electric generator 130.

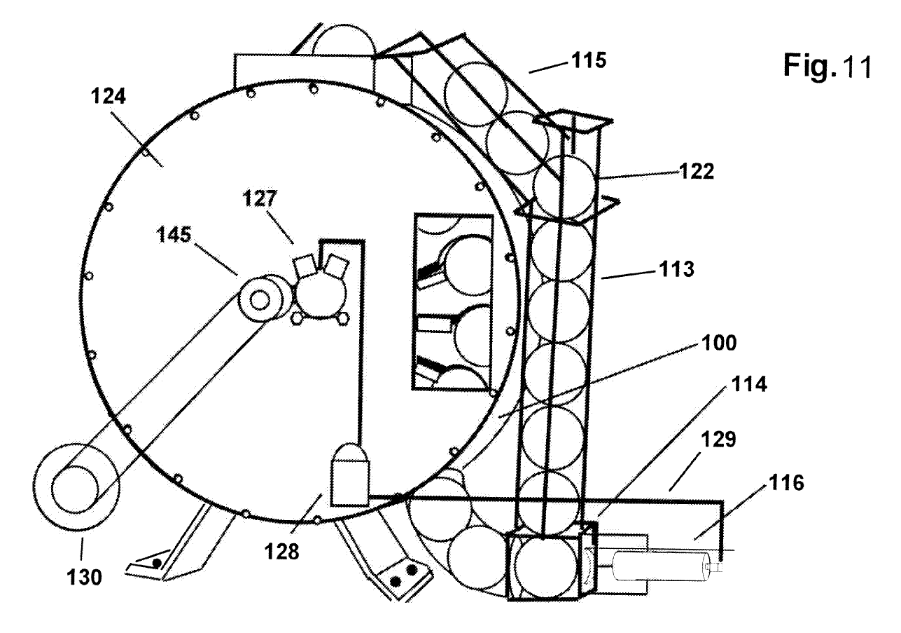

FIG. 11 is a front view of an embodiment of the present device depicting a tank 100, buoy return assembly, pneumatic piston assembly, inflatable buoys, panel 124, and various external components depicted in FIG. 10, all shown in operable position with respect to one another and the device as a whole.

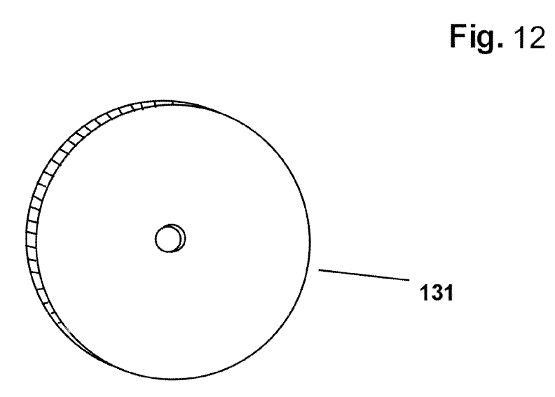

FIG. 12 provides a perspective view of one embodiment of a starter gear 131 of the present invention.

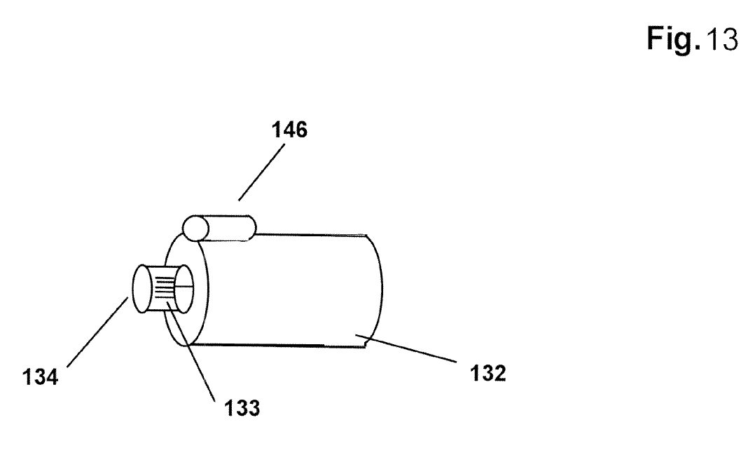

FIG. 13 provides a perspective view of one embodiment of a starter motor of the present invention. The starter motor includes motor 132, bendix gear 133, bendix housing 134, and solenoid 146.

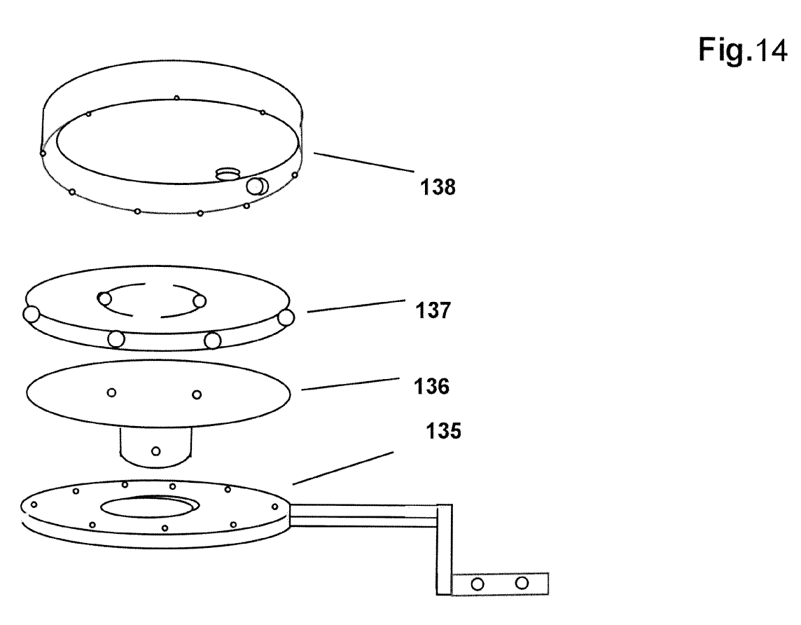

FIG. 14 provides an exploded view of one embodiment of a timing assembly of the present invention. Shown are mounting bracket 135, motor shaft mounting plate 136, adjustable timing wheel 137, and contact cap 138. The operation of the timing assembly, as well as other aspects of the present invention, is detailed below.

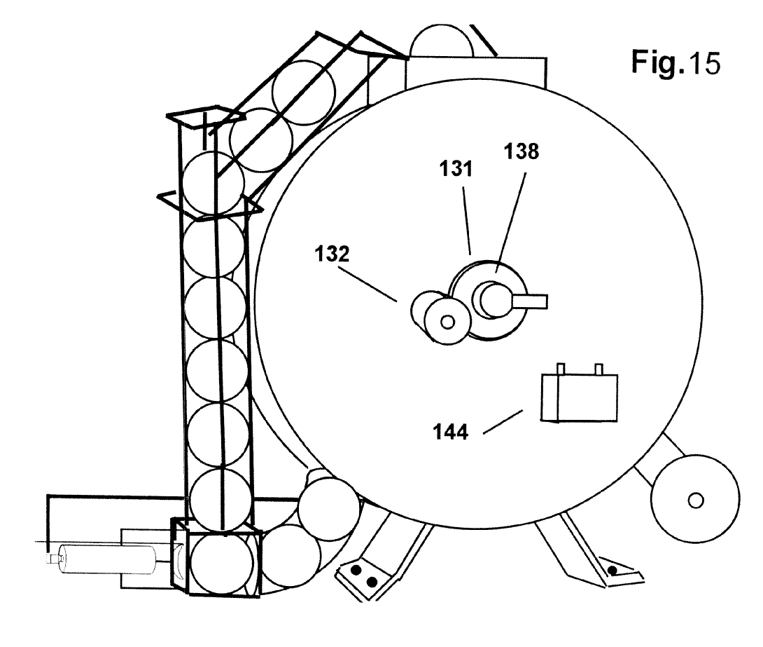

FIG. 15 is a rear view of one embodiment of the present invention, the drawing showing a battery 144, starter gear 131, starter motor 132, and timing assembly 138 in operable position with respect to one another and the device as a whole.

Now detailed is the operation of the embodiment of the present invention depicted in FIGS. 2 through 15. Operation of this embodiment of the device is preferably initiated by filling tank 100 with water or other suitable fluid. Displaced fluid receptacle 102 should remain free of fluid after tank 100 is filled. Further, compressed air tank 128 should be filled with the desired air pressure and battery 144 should be fully charged. Buoys 122, such as, for example, inflatable buoys, should fill buoy delivery compartment 114, buoy magazine cage 113, and buoy return track 115. In embodiments of the present invention utilizing inflatable buoys 122, the buoys should be inflated sufficiently to make snug contact with the inner wall of buoy insertion tube 101, in order to retain the water-tight seal of tank 100. FIG. 11 provides an exemplary depiction of an embodiment of the present invention with buoys 122 in place.

A start switch (not shown) is used to activate starter motor 132 and solenoid 145, causing bendix gear 133 to move forward and make contact with starter gear 131. This then turns the rotor assembly inside tank 100. The rotating rotor assembly causes the water inside tank 100 to move in a circular motion within the tank. As the rotation of the water within tank 100 increases in speed, centrifugal force causes the water to move away from the center of tank 100 and toward the outer wall thereof. A volume of the water is forced into displaced water receptacle 102. When the water circulating in the tank reaches a desired speed, a flow switch (not shown) within tank 100 disengages starter motor 132 and engages the timing assembly.

Adjustable timing wheel 137 is attached to shaft 110 by motor shaft mounting plate 136, and is fitted with electrical contacts on its outer edge that correspond in scale to the distance between individual drive fins 107. The timing assembly is in direct electrical connection with solenoid valve 117 of the pneumatic piston assembly. Each time the contact points on the timing assembly are engaged, solenoid valve 117 opens, allowing compressed air to flow from compressed air storage 128 through compressed air line 129 and into cylinder 116, driving piston and rod 119 and drive head 120 forward into a buoy 122 in buoy delivery compartment 114. This action pushes the buoy 122 into buoy insertion tube 101, and pushes a buoy 122 already in buoy insertion tube 101 into tank 100. As piston and rod 119 and drive head 120 move forward, buoy retention rod 121 prevents other buoys 122 from falling into buoy delivery compartment 114, until piston and rod 119 and drive head 120 have returned to their previous position.

A buoy 122 enters tank 100 precisely between drive fins 107. As a buoy 122 leaves pod insertion tube 101, the buoy's entry into tank 100 is aided by the water circulating in tank 100, so that the buoy 122 is not being driven into static pressure. The buoyancy of the buoy 122 causes it to immediately push upward against one of drive fins 107, keeping constant pressure on the rotor assembly and causing continued motion thereof.

Several buoys 122 may be in motion within tank 100 at any given time. Alternatively, the timing of the present device may be adjusted to intermittently insert a buoy 122 in order to take advantage of the inertia created by the rotating rotor assembly and circulating water and thereby lessening the energy consumption per unit of time of the device.

Push wings 108 are preferably designed in a “V” shape in order to have as little resistance as possible when moving forward. The open-style back of push wings 108 take advantage of the push of water when the force from buoys 122 stops. When buoys 122 reach the top of the rotor assembly, they are released and rise to the top of displaced water receptacle 102 and are deflected into buoy return track 115 by buoy deflector 104, and the process repeats continuously. This action powers an electric generator 130. The electric generator 130 also preferably serves to recharge the battery and power the electrical components of the device during operation.

It is to be understood that the above description is intended to be illustrative and not limiting. Many other embodiments and variations of the invention will be apparent to those of skill in the art upon reading this disclosure.

1. A device for producing electricity comprising:
a housing containing a volume of fluid therein, the housing having an inlet and an outlet;
a rotor within said housing, the rotor fixedly attached to a shaft and in fluid communication with said housing;
at least one buoy sized and shaped to move through said inlet and said outlet; and
an electrical generator coupled to said shaft,
wherein said rotor is adapted to receive said at least one buoy,
and further wherein when said at least one buoy enters said housing, said buoy rises within the volume of fluid contained therein and is received by said rotor,
and further wherein the rising action of said buoy causes a corresponding rotation of said rotor by which said electrical generator is operated.

2. The device according to claim 1, wherein said volume of fluid has a first density and said at least one buoy has a second density, and further wherein said first density is greater than said second density.

3. The device according to claim 1, wherein said at least one buoy is selected from the group consisting of metal buoys, wooden buoys, synthetic polymer buoys, carbon fiber buoys, foam, buoys, inflatable buoys, and combinations thereof.

4. The device according to claim 1, wherein said at least one buoy is hollow.

5. The device according to claim 4, wherein said at least one buoy is filled with a gas.

6. The device according to claim 5 wherein said gas is selected from the group consisting helium and hydrogen.

7. The device according to claim 4 wherein said at least one buoy contains a vacuum.

8. A device for producing electricity comprising:
a housing containing a volume of fluid therein, the housing having an inlet and an outlet;
a rotor within said housing, the rotor fixedly attached to a shaft and in fluid communication with said housing;
a plurality of buoys sized and shaped to move through said inlet and said outlet;
at least one arm extending radially from said rotor, said arm adapted to receive at least one of said plurality of buoys;
an electrical generator coupled to said shaft;
a buoy return track extending outward and downward from said outlet of said housing, said buoy return track outside of said housing and adapted to guide buoys emerging from said housing;
a buoy magazine cage fixedly attached to said buoy return track and adapted to receive a plurality of buoys therein; and
a buoy inlet tube fixedly attached at a first end to said buoy magazine cage, and at a second end to said inlet of said housing, and adapted to direct a plurality of buoys into said housing,
wherein when said at least one buoy enters said housing, said buoy rises within the volume of fluid contained therein and is received by said rotor,
and further wherein the rising action of said buoy causes a corresponding rotation of said rotor by which said electrical generator is operated.

9. The device according to claim 8 further comprising a receiving portion fixedly attached to said at least one arm, said receiving portion adapted to receive at least one of said plurality of buoys.

10. The device according to claim 8, wherein said at least one arm further comprises a fin fixedly attached to a length thereof, said fin disposed such that movement of fluid within said housing impacts said fin and causes a corresponding movement of said rotor.

11. The device according to claim 8 further comprising;
an insertion mechanism in communication with said buoy inlet tube, the insertion mechanism adapted to apply a force to one of said plurality of buoys, thereby forcing another of said plurality of buoys into said housing.

12. The device according to claim 11 further comprising:
a timing mechanism in communication with said insertion mechanism, such that one of said plurality of buoys is forced into said housing at a time when said at least one arm is in position to receive said one of said plurality of buoys.
